(19) United States
(12) Patent Application Publication
(10) Pub. No.: US 2005/0132135 A1
(43) Pub. Date: Jun. 16, 2005

(54) [METHOD OF RAID EXPANSION]

(76) Inventor: Hung Ming Chien, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/710,820

(22) Filed: Aug. 5, 2004

(30) Foreign Application Priority Data
Dec. 15, 2003 (TW) 92135339

(51) Int. Cl. G06F 12/00

(52) U.S. Cl. 711/114; 711/170

(57) ABSTRACT

A method of redundant array of independent disks (RAID) expansion is provided. The RAID includes M number of storage devices, each of the storage devices has N number of data blocks, and the data blocks, for example, are sequentially arranged with a RAID 5 combination architecture. The method of expanding RAID includes disposing an expansive storage device in front of the M storage devices, then the data blocks except the parity data blocks are sequentially moved to the new data blocks, and the position of the new parity data blocks is the same as the position of the original parity data blocks.

### CROSS REFERENCE TO RELATED APPLICATIONS

This application claims the priority benefit of Taiwan application serial no. 92135339, filed Dec. 15, 2003.

### BACKGROUND OF INVENTION

1. Field of the Invention

The present invention relates to a method for storing data, and more particularly, to a method of expanding an redundant array of independent disks (RAID).

2. Description of the Related Art

In a storage system with multiple disk arrays, the redundant array of independent disks (abbreviated as RAID hereinafter) is a technique which integrates several small size physical disks to form an extendable logical drive. When storing a data, the data is split into several data blocks and each data block is stored in a separate physical disk. Since the access operation is performed simultaneously, better data access efficiency is provided by the RAID technique. In addition, in order to prevent the data loss due to some physical disk damage, the RAID technique also applies the parity check concept for rebuilding data when necessary.

In general, the RAID system is classified as several levels based on the RAID type of the physical disk and the way it stores data, and the commonly seen RAID system on the current market comprises following types.

RAID 0, in which a data is split into several blocks, and each block is written into a separate physical disk (it is the so-called “Data stripping”). Thus the RAID 0 provides better access efficiency. However, since the RAID 0 does not support fault tolerance and data rebuild, if one of the physical disks fails, the data is lost. Therefore, it is only suitable in a circumstance where the data being not so important needs to be accessed in a fast speed.

RAID 1, in which two physical disks are treated as a logical drive, and the data is stored into two physical disks simultaneously. When one of the physical disks is damaged, the same data can be accessed from the other physical disk so as to prevent the important data from being lost.

RAID 3, in which a physical disk is reserved as a parity disk for storing a parity data, and other data is evenly stored in other physical disks. When some of the physical disks are damaged, the disk controller can recover the data by using the parity data stored previously.

RAID 5 is different from RAID 3 in that the parity data is distributed and saved in each physical disk without having to allocate a dedicated parity disk. Thus, the RAID 5 is also known as a “Rotating Parity Array”. Wherein, the data is evenly stored in each physical disk like in RAID 3. When one of the physical disks is damaged, the disk controller can recover the data by using the parity data stored previously.

FIGS. 1˜3 are the schematic diagrams illustrating a conventional method of expanding RAID. Referring to FIG. 1, the RAID disk array 100 comprises M number of storage devices 110, which are connected to a RAID controller 130 via a transmission line 120, respectively. The RAID controller 130, for example, writes data into the data block 112 of different storage device 110 with a RAID 5 combination architecture, and each storage device 110 comprises N data blocks 112. Herein, D_{I,J} is defined as the J^{th} data block 112 of the I^{th} storage device 110, and P_{I,J} is defined as the J^{th} parity data block 112 of the I^{th} storage device 110. Wherein, I is a positive integer of 1˜M, J is a positive integer of 1˜N. When the data block D_{I,J} is the parity data block P_{I,J}, the data block D_{I-1,J+1} is the parity data block P_{I-J,J+1}, too.

As shown in FIG. 1, when the parity data block P_{M,1} of the first row's data string is disposed on the M^{th} storage device 110 which is on the right most column, the parity data block P_{M-1,2} of the second row's data string is sequentially disposed on the (M−1)^{th} storage device 110, and the rest can be deduced by analogy. Therefore, the arrangement of the parity data block P_{I,J} is from the right to the left, is sequentially decreased by a storage device 110, and from the top to the bottom, sequentially increased by a column of the data block. The parity block of (M+1)^{th} rows' data string would be disposed on the M^{th} storage device 110, and the parity block of (M+2)^{th} row's data string would be disposed on the (M−1)^{th} storage device 110. As to parity block of (M+M)^{th} rows' data string would be disposed on the 1^{th} storage device 110. And the disposition of pariry would follow this scheme cyclically for every M rows of data string, so as to comply with the arrangement method of the RAID 5.

Referring to FIG. 2, it is to be emphasized that when another storage device 114 is being expanded, the conventional art uses the expansive storage device 114 as its (M+1)^{th} storage device 110, which is arranged after the original M storage devices 110, thus the Y^{th} data block of the extensive storage device 114 is represented as D_{M+1,Y}. However, when sequentially (in an ascending order) moving the data blocks D_{1,1}˜D_{M,N} (except the parity data blocks) to the new data blocks D_{1,1}˜D_{M+1,N}, part of the new parity data, e.g. P_{M,2} will overlay the data block D_{M, 2} which has not been moved yet as shown in FIG. 3. In order to maintain the integrity of the data block, the conventional method moves the data block which are in the overlapped region and has not been moved yet to a temporary storing area in advance, e.g. another disk area, a NVRAM temporary storing memory, or a memory with power provided by a battery, so as to prevent the data from being overlapped by the new parity data. Where the overlapped region always happens in D_{1,1}˜D_{M,M}, and we call this region as early block here because it is the beginning blocks of total blocks of D_{1,1}˜D_{M.N}. Since the conventional technique has to sequentially write the data on the early block of D_{1,1}˜D_{M,M} to the temporary storing area, the effective bandwidth for system to read data is decreased, and the data stored in the temporary storing area is lost when the system power is interrupted.

### SUMMARY OF INVENTION

Therefore, it is an object of the present invention to provide a method of expanding an redundant array of independent disks (RAID). With this method, the data block which has not been moved in the early blocks is not overlapped by the new parity data block before moving the data.

In accordance with the objects mentioned above, a method of expanding RAID is provided by the present invention. The RAID comprises M storage devices, and each of the storage devices comprises N storage blocks, which are defined as:
DI,J the J^{th} data block of the I^{th} storage device; and
PI,J: the J^{th} data block of the I^{th} storage device, and it is a parity data block.

Wherein, I is a positive integer of 1˜M, J is a positive integer of 1˜N, and the arrangement order of the storage devices is: if D_{I,J}=P_{I,J}, then D_{I-1,J+1}=P_{I-1,J+1}. The method of expanding RAID comprises following steps:
providing an expansive storage device and disposing the expansive storage device in front of the storage devices, and the Y^{th} data block of the expansive storage device is represented as D_{0,Y}; and
sequentially moving the D_{I,J} data blocks except P_{I,J}, wherein X is a positive integer of 0˜M, Y is a positive integer of 1˜N, and if D_{X,Y}=P_{X,Y}, then D_{X-1,Y+1}=P_{X-1,Y+1}.

In accordance with a preferred embodiment of the present invention, the step of sequentially moving D_{I,J} mentioned above further comprises sequentially moving in an ascending order based on the sequence of the I value and/or J value.

In the present invention, since the new parity data block does not overlay the data block which has not been moved in the early blocks, instead the new parity data block overlays the parity data block on the same position, it is not necessary to move the data block which has not been moved in the early blocks to the temporary storing area in advance. Accordingly, the efficiency of system reading data is improved, and the concern of the data loss due to the system power interruption is eliminated.

### BRIEF DESCRIPTION OF DRAWINGS

The accompanying drawings are included to provide a further understanding of the invention, and are incorporated in and constitute a part of this specification. The following drawings illustrate embodiments of the invention, and together with the description, serve to explain the principles of the invention.

FIGS. 1˜3 are the schematic diagrams illustrating a conventional method of expanding RAID.

FIGS. 4˜6 are the schematic diagrams illustrating a method of expanding RAID according to a preferred embodiment of the present invention.

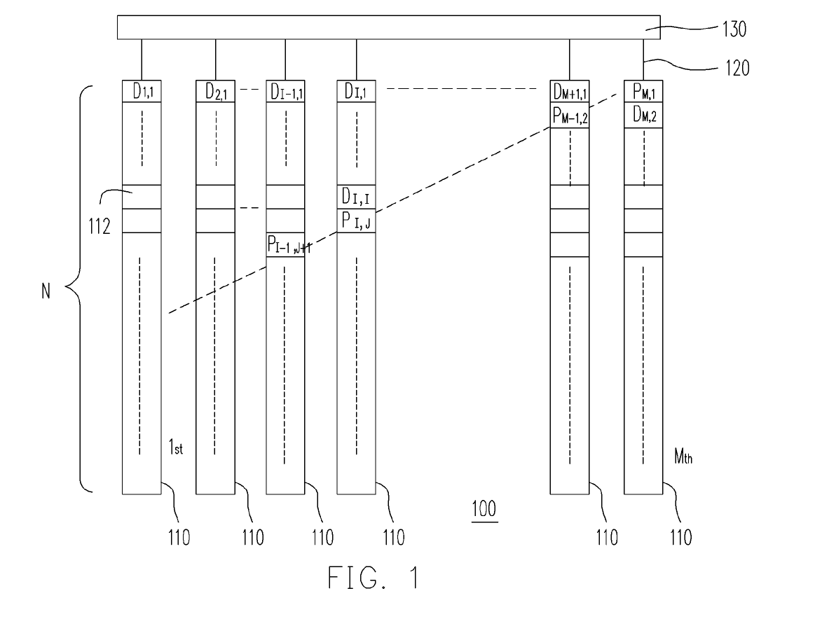

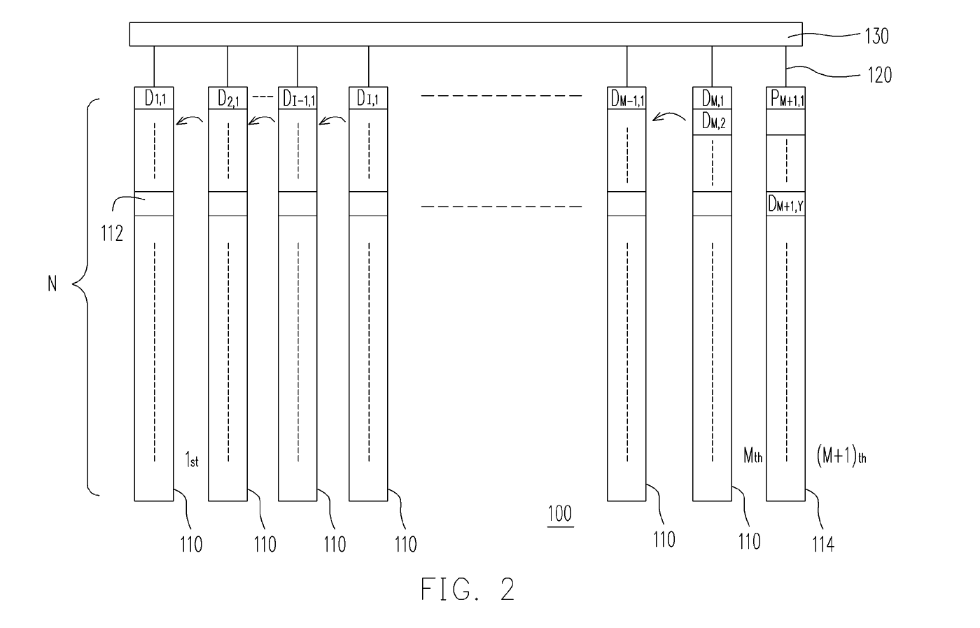

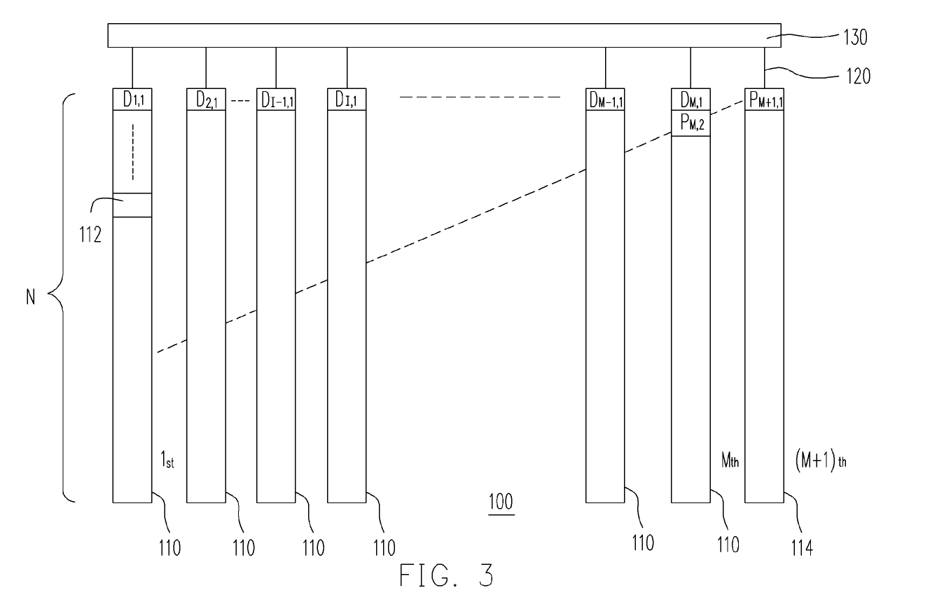

### DETAILED DESCRIPTION

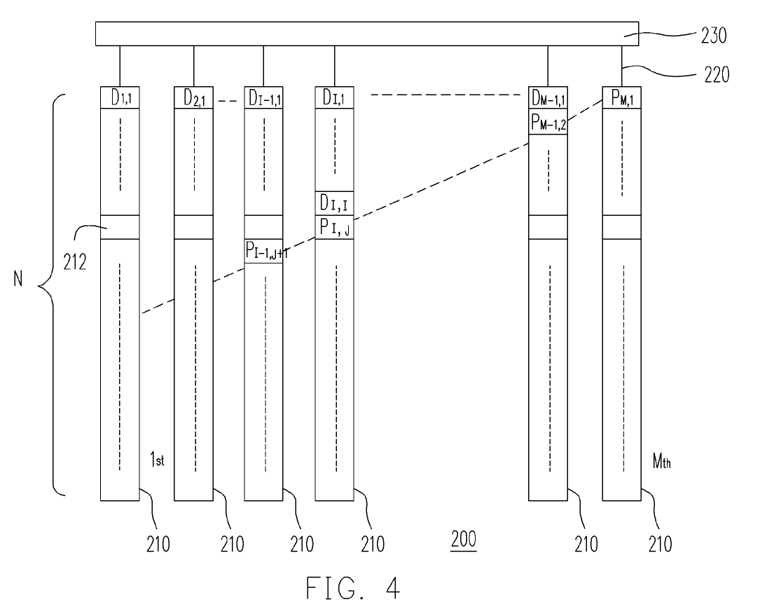

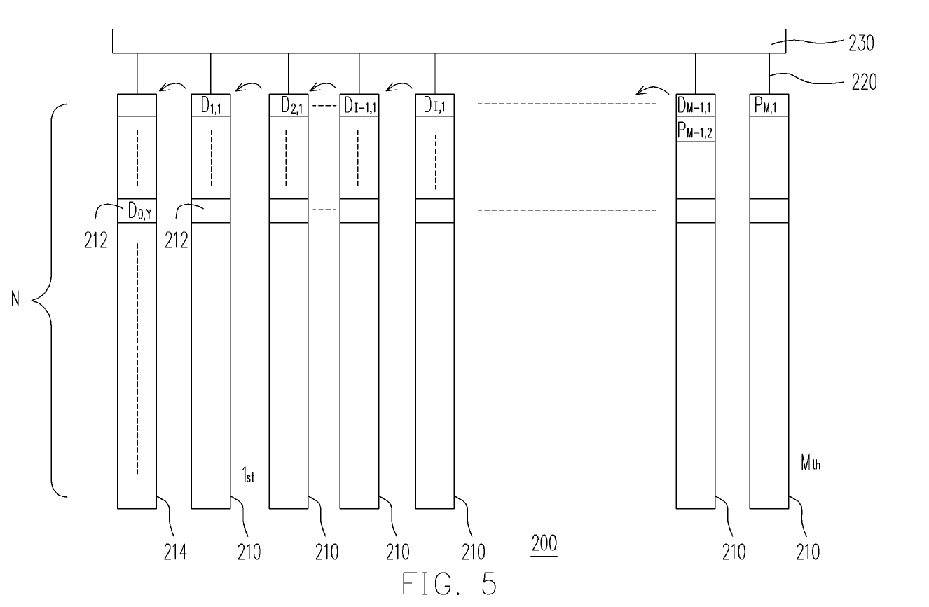

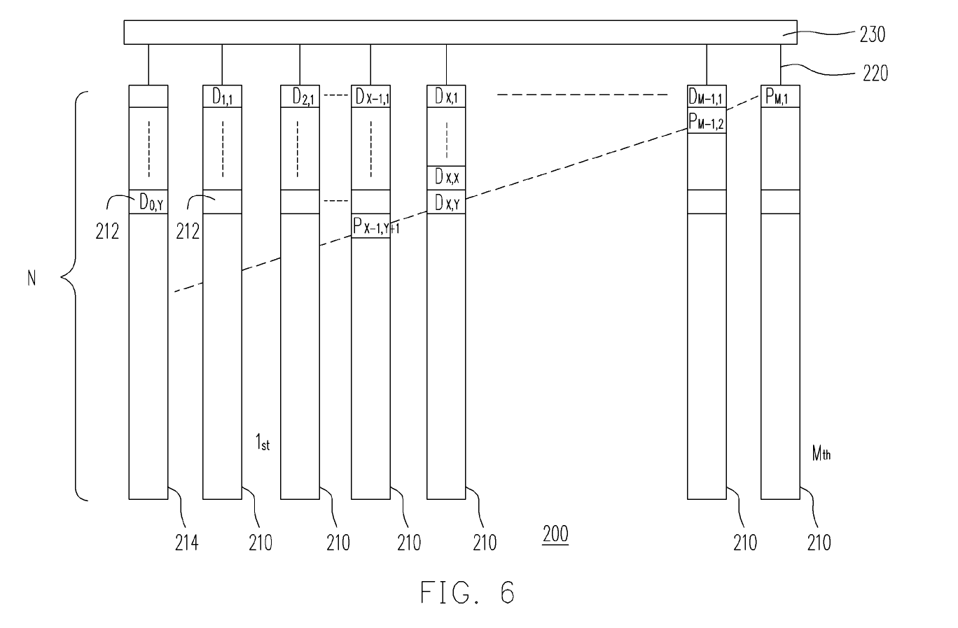

FIGS. 4˜6 are the schematic diagrams illustrating a method of expanding RAID according to a preferred embodiment of the present invention. Referring to FIG. 4, the RAID disk array 200 comprises M number of storage devices 210, which are connected to a RAID controller 230 via a transmission line 220, respectively. The RAID controller 230 writes data into the data block 212 of different storage device 210 with a RAID 5 combination architecture, and each storage device 210 comprises N data blocks 212. Herein, D_{I,J} is defined as the J^{th} data block 212 of the It storage device 210, and P_{I,J} is defined as the J^{th} parity data block 212 of the I^{th} storage device 210. Wherein, I is a positive integer of 1˜M, J is a positive integer of 1˜N. When the data block D is the parity data block P the data block D is the parity data block P_{I-1,J+1}, too.

As shown in FIG. 4, it is assumed that when the parity data block P_{M,1} of the first row's data string is disposed on the M^{th} storage device 210 which is on the right most column, the parity data block P_{M-1,2} of the second row's data string is sequentially disposed on the (M−1)^{th} storage device 210, and the rest can be deduced by analogy. Therefore, the arrangement of the parity data block P_{I,J} is from the right to the left is sequentially decreased by a storage device 210, and from the top to the bottom is sequentially increased by a row of the data block, which is the so-called “left symmetry”. Accordingly, in these storage devices 210, the data string of the same row's data block 212 only comprises a unique parity data block, and each column's parity data block is disposed on different device 210, so as to comply with the arrangement method of the RAID 5. However, the storage device 210 is not limited to use the RAID 5 arrangement, and there is no limitation for only one parity data block in the data string of the same column's data block 212, instead multiple parity data blocks are also acceptable.

Referring to FIG. 5, it is to be emphasized that when another storage device 214 is being expanded, the present embodiment disposes the expansive storage device 214 in front of the original M storage devices 210, and the Y^{th} data block 212 of the extensive storage device 214 is represented as D_{0,Y}. It is different from the conventional art in that when sequentially (in an ascending order) moving the data blocks D_{1,1}˜D_{M,N} (except the parity data blocks) to the new data block D_{X,Y} wherein X is a positive integer of 0˜M, Y is a positive integer of 1˜N, and have the data block D_{X,Y} equal to the parity data block P_{X,Y}, the data block D_{X-1,Y+1} is equal to the parity data block P_{X-1,Y+1}, too. In other words, in the storage devices 210, the position of the parity data block P_{X,Y} within the early block of the same J^{th} data block 212 is not changed due to the expansion.

As shown in FIG. 5, in the present embodiment, when the parity data block P_{M,1} of the first column's data string is disposed on the M^{th} storage device 210 which is on the right most column, the expansive storage device 214 is disposed in front of the first storage device 210 which is on the left most column, and the parity data block P_{X,Y} is sequentially disposed from the top right to the bottom left. Similarly, in another embodiment (not shown), when the parity data block P_{M,1} of the first row's data string is disposed on the M^{th} storage device 210 which is on the left most column, the expansive storage device is disposed in front of the first storage device which is on the right most column, and the parity data block P_{X,Y} is sequentially disposed from the top left to the bottom right. Therefore, when the first row's data string is sequentially moved to the expansive storage device 214 on the left hand side and the storage device 210, the position of the original parity data block P_{M,1} (in the M^{th} storage device 210) is maintained as the position of the new parity data block P_{M,1}. Similarly, when the second row's data string is sequentially moved to the expansive storage device 214 on the left hand side and the storage device 210, the position of the original parity data block P_{M-1,2} (in the (M−1)^{th} storage device) is maintained as the position of the new parity data block P_{M-1,2}, and the rest can be deduced by analogy. Therefore, the new parity data block does not overlay the data block in the early blocks (D_{1,1}˜D_{M,M}) and has not been moved yet, instead the new parity data block overlays the original parity data block on the same position.

Since the new parity data does not overlay the data block which has not been moved in the early blocks, the system need not move the data block which has not been moved in the early blocks to a temporary storing area, e.g. another disk area, a NVRAM temporary storing memory, or a memory with power provided by a battery. Accordingly, the workload when system reading the data is eliminated, the system effective bandwidth is improved, and the problem of losing data stored in the temporary storing area does not occur.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A method of expanding an redundant array of independent disks (RAID), wherein the RAID comprises M number of storage devices, and each of the storage devices comprises N number of storage blocks, which are defined as:
D_{I,J}: the J^{th} data block of the I^{th} storage device;
P_{I,J}: the J^{th} data block of the I^{th} storage device, being a parity data block;
wherein, I is a positive integer of 1˜M,J is a positive integer of 1˜N, and the arrangement order of the storage devices is: if D_{I,J}=P_{I,J}, then D_{I-1,J+1}=P_{I-1,J+1}, the method comprising:
providing an expansive storage device;
disposing the expansive storage device in front of the storage devices, wherein the Y^{th} data block of the expansive storage device is represented as D_{0,Y}; and
sequentially moving the D_{I,J} data blocks except P_{I,J}, wherein Y is a positive integer of 1˜N, and if D_{X,Y}=P_{X,Y}, then D_{X-1,Y+1}=P_{X-1,Y+1}, and wherein X is a positive integer of 0˜M.

2. The method of expanding RAID of claim 1, wherein the step of sequentially moving D_{I,J} further comprises sequentially moving D_{I,J} in an ascending order based on the sequence of an I value.

3. The method of expanding RAID of claim 1, wherein the step of sequentially moving D_{I,J} further comprises sequentially moving D_{I,J} in an ascending order based on the sequence of a J value.

4. A method of expanding an redundant array of independent disks (RAID), wherein the RAID comprises M number of storage devices, and each of the storage devices comprises N number of storage blocks, which are defined as:
D_{I,J}: the J^{th} data block of the I^{th} storage device;
P_{I,J}: the J^{th} data block of the I^{th} storage device, being a parity data block;
wherein, I is a positive integer of 1˜M, J is a positive integer of 1˜N, and a same J^{th} data block in the storage devices comprises at least a parity data block, the method comprising:
providing an expansive storage device;
disposing the expansive storage device in front of the storage devices, and the Y^{th} data block of the expansive storage device is represented as D_{0,Y}; and
sequentially moving the D_{I,J} data blocks except P_{I,J}, wherein Y is a positive integer of 1˜N, and the positions of the parity data block of the same J^{th} data block in the storage devices are the same.

5. The method of expanding RAID of claim 4, wherein the step of sequentially moving D_{I,J} further comprises sequentially moving D_{I,J} in an ascending order based on the sequence of an I value.

6. The method of expanding RAID of claim 4, wherein the step of sequentially moving D_{I,J} further comprises sequentially moving D_{I,J} in an ascending order based on the sequence of a J value.
